(19) United States
(12) Patent Application Publication
(10) Pub. No.: US 2008/0256296 A1
(43) Pub. Date: Oct. 16, 2008

(54) INFORMATION PROCESSING APPARATUS AND METHOD FOR CACHING DATA

(75) Inventor: Seiji MAEDA, Kawasaki-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/035,977

(22) Filed: Feb. 22, 2008

(30) Foreign Application Priority Data
Apr. 12, 2007 (JP) 2007-104582

(51) Int. Cl. G06F 12/00

(52) U.S. Cl. 711/118; 711/E12.001

(57) ABSTRACT

A processor is provided with a register and operates to: determine whether a first tag address match with a second tag address, the first tag address being derived from a target main memory address that is to be accessed for obtaining target data subjected to a computation, the second tag address being one of the tag addresses stored in the local memory; start copying data stored in at least one of the cache lines assigned with a line number that matches with a target line number that is derived from the target main memory address into the register before completing the determination of match between the first tag address and the second tag address; and access the register to obtain the data copied from the local memory when determined that the first tag address match with the second tag address.

### RELATED APPLICATION(S)

The present disclosure relates to the subject matter contained in Japanese Patent Application No. 2007-104582 filed on Apr. 12, 2007, which is incorporated herein by reference in its entirety.

### FIELD

The present invention relates to an information processing apparatus and method for caching data.

### BACKGROUND

In a recent computer system, there has widely been used a temporary storage device, such as a cache memory or a local memory, which has a smaller capacity and a higher data transfer rate than those of a main memory in order to compensate for a difference between a data process speed of a processor and the data transfer rate of the main memory. In such computer system, it is possible to increase an effective transfer rate of data on the main memory and to make the best of the data process speed of the processor by temporarily storing a part of the data on the main memory in the temporary storage device.

However, all of the data on the main memory cannot be cached in the temporary storage device. Therefore, before the processor accesses to the data on the temporary storage device, a determination whether the data to be accessed are stored in the temporary storage device, which is called a cache hit determination, is performed. In a case in which the cache hit determination is performed by software, particularly, there is a problem in that a considerable amount of time is required for the cache hit determination and a time required for a data access to the temporary storage device is prolonged.

Therefore, there is proposed a technique for predicting data stored in the temporary storage device from a result of the cache hit determination performed previously and output the same data from the temporary storage device before performing the cache hit determination. An example of such technique is disclosed in JP-A-5-120135.

In the technique described in JP-A-5-120135, however, the data are output from the temporary storage device before performing the cache hit determination. After the cache hit determination is completed, however, the output data are stored in a register provided in the processor and are used for a calculation. For this reason, it is impossible to sufficiently shorten a time required for a data access to the temporary storage device from the processor.

### SUMMARY

According to a first aspect of the invention, there is provided an information processing apparatus including: a local memory that caches a part of data stored in a main memory, which stores the data by main memory addresses, in one of a plurality of cache lines that are grouped into a plurality of ways, each of the cache lines being assigned with line numbers that are unique with one another in each of the ways, the local memory storing tag addresses that identify the data cached in the cache lines, the line numbers and the tag addresses being derivable from the main memory addresses; and a processor that is provided with a register and operates to: determine whether a first tag address match with a second tag address, the first tag address being derived from a target main memory address that is to be accessed for obtaining target data subjected to a computation, the second tag address being one of the tag addresses stored in the local memory; start copying data stored in at least one of the cache lines assigned with a line number that matches with a target line number that is derived from the target main memory address into the register before completing the determination of match between the first tag address and the second tag address; and access the register to obtain the data copied from the local memory when determined that the first tag address match with the second tag address.

According to a second aspect of the invention, there is provided a method for caching data in an information processing apparatus including: a local memory that caches a part of data stored in a main memory, which stores the data by main memory addresses, in one of a plurality of cache lines that are grouped into a plurality of ways, each of the cache lines being assigned with line numbers that are unique with one another in each of the ways, the local memory storing tag addresses that identify the data cached in the cache lines, the line numbers and the tag addresses being derivable from the main memory addresses; and a processor that is provided with a register and performs computation of the data, wherein the method includes: determining whether a first tag address match with a second tag address, the first tag address being derived from a target main memory address that is to be accessed by the processor for obtaining target data subjected to the computation, the second tag address being one of the tag addresses stored in the local memory; starting to copy data stored in at least one of the cache lines assigned with a line number that matches with a target line number that is derived from the target main memory address into the register before completing the determination of match between the first tag address and the second tag address; and accessing the register by the processor to obtain the data copied from the local memory when determined that the first tag address match with the second tag address.

According to a third aspect of the invention, there is provided a computer-readable storage medium that stores a program for caching data in an information processing apparatus including: a local memory that caches a part of data stored in a main memory, which stores the data by main memory addresses, in one of a plurality of cache lines that are grouped into a plurality of ways, each of the cache lines being assigned with line numbers that are unique with one another in each of the ways, the local memory storing tag addresses that identify the data cached in the cache lines, the line numbers and the tag addresses being derivable from the main memory addresses; and a processor that is provided with a register and performs computation of the data, wherein the program causes the processor to perform a process including: determining whether a first tag address match with a second tag address, the first tag address being derived from a target main memory address that is to be accessed by the processor for obtaining target data subjected to the computation, the second tag address being one of the tag addresses stored in the local memory; starting to copy data stored in at least one of the cache lines assigned with a line number that matches with a target line number that is derived from the target main memory address into the register before completing the determination of match between the first tag address and the second tag address; and accessing the register by the processor to obtain the data copied from the local memory when determined that the first tag address match with the second tag address.

### BRIEF DESCRIPTION OF THE DRAWINGS

In the accompanying drawings:

FIG. 1 is a block diagram showing a configuration of an information processing apparatus according to an embodiment of the invention;

FIG. 2 is a diagram showing a configuration of a main memory address output from a processor according to the embodiment;

FIG. 3 is a diagram showing a configuration of a local memory according to the embodiment;

FIG. 4 is a diagram showing a configuration of a tag array stored in the local memory according to the embodiment;

FIG. 5 is a block diagram showing an input/output relationship of data to be used by a cache data control program executed by the processor according to the embodiment;

FIG. 6 is a flowchart showing an operation of the information processing apparatus according to the embodiment; and

FIG. 7 is a flowchart showing the operation of the information processing apparatus according to the embodiment.

### DETAILED DESCRIPTION OF THE EMBODIMENTS

Referring now to the accompanying drawings, an embodiment of the present invention will be described in detail.

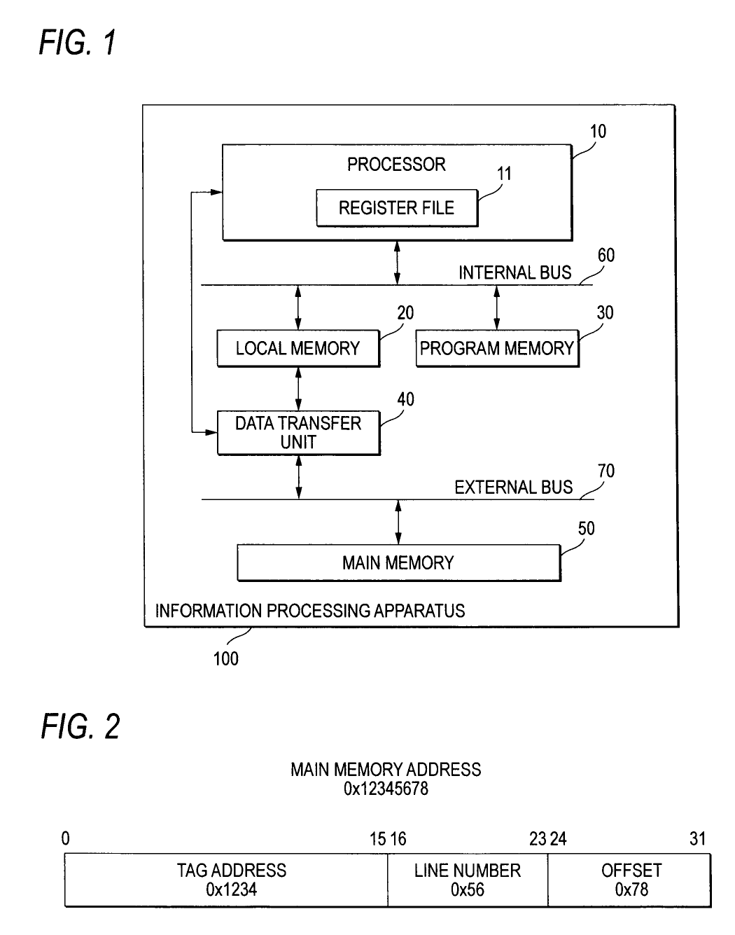

FIG. 1 is a block diagram showing an information processing apparatus 100 according to an embodiment of the present invention.

The information processing apparatus 100 according to the embodiment includes: a processor 10 that performs a process using data stored in a main memory 50; a program memory 30 that stores a program to be executed by the processor 10; a local memory 20 that stores a part of the data stored in the main memory 50; a data transfer unit 40 that performs a data transfer between the main memory 50 and the local memory 20 in response to a request from the processor 10; and the main memory 50 that supplies data to the local memory 20 through the data transfer unit 40.

The processor 10 includes a register file 11 for storing data to be used in the process. The register file 11 is configured by a plurality of registers (not shown). Storage capacities of the respective registers and a data unit in which data are transferred by the processor 10 between the local memory 20 and the register file 11 are set to be 32 bits, for example.

The processor 10, the local memory 20 and the program memory 30 are connected through an internal bus 60. The data transfer unit 40 and the main memory 50 are connected through an external bus 70.

The processor 10 executes a program stored in the program memory 30 or the local memory 20. It is sufficient that a program to be executed by the processor 10 uses the data stored in the main memory 50, and the program may be a firmware, a middleware or an operating system.

The data transfer unit 40 is implemented by a direct memory access controller (a DMA controller), for example, and transfers specified data from the local memory 20 to the main memory 50 or from the main memory 50 to the local memory 20 in response to a request from the processor 10. The data transfer unit 40 is controlled by the processor 10 and manages data copy between the main memory 50 and the local memory 20.

The program memory 30 stores a program to be executed by the processor 10. The program memory 30 is configured by an RAM (Random Access Memory) or an ROM (Read Only Memory) The local memory 20 is configured by the RAM and temporarily stores (caches) the data of the main memory 50.

FIG. 2 shows a configuration of a main memory address output from the processor 10.

It is assumed that a bit width of the main memory address is set to be 32 bits, for example, and each main memory address specifies 1-byte data stored in the main memory 50. In this case, the main memory address can specify 4 GB data on the main memory.

The main memory address is configured by a tag address having a 16-bit width, a line number having an 8-bit width and an offset having an 8-bit width. In the example shown in FIG. 2, the tag address is “0x1234”, the line number is “0x56” and the offset is “0x78”. The tag address, the line number and the offset will be described below.

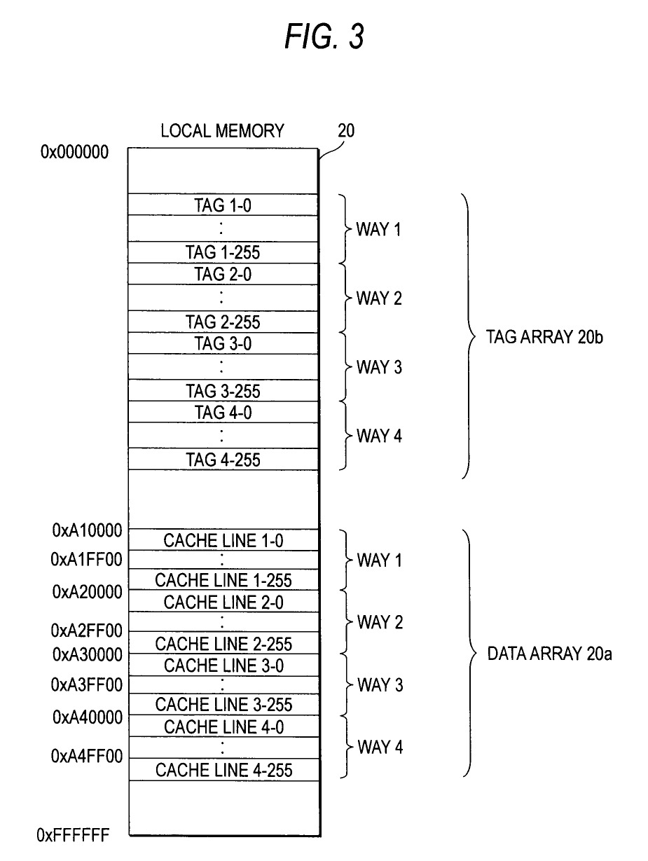

FIG. 3 shows a configuration of the local memory 20 according to the embodiment. In FIG. 3, a cache line of a data array and a tag (management information) of a tag array are described as “cache line (way number)-(line number)” and “tag (way number)-(line number)”. For example, “cache line 3-255” indicates a cache line having a way number of “3” and a line number of “255 (0xFF)”.

The local memory 20 stores a data array 20a for temporarily storing data on the main memory 50 every cache line (a cache line has a capacity of 256 bytes), and a tag array 20b for storing, every cache line, a tag (management information) of the data to be stored in the data array 20a. Local memory addresses of “0x000000” to “0xFFFFFF” are assigned to the local memory 20. For example, it is assumed that the capacity of the local memory 20 is set to be 16 MB and 1-byte data stored in the local memory 20 are specified by each of the local memory addresses.

The line number of the main memory address is used for identifying the cache line of the data array 20a. The tag address of the main memory address is used for identifying the data stored in the cache line of the data array 20a. The offset is used for identifying an order of any of the data (256 bytes) stored in the cache line of the data array 20a.

For example, the data array 20a and the tag array 20b are configured to be 4-way. More specifically, it is assumed that four cache lines (cache lines 1-1, 2-1, 3-1 and 4-1) and management information (tags 1-1, 2-1, 3-1 and 4-1) added every cache line are specified based on one line number (for example, a line number of “0x01”). The number of the cache lines possessed by the data array 20a and that of the tags possessed by the tag array 20b are equal to each other.

The line number of the main memory address shown in FIG. 2 has an 8-bit width, and a line number of “0 to 255” can be specified. Therefore, the number of the tags added every cache line held by the data array 20a and every cache line held by the tag array 20b is “1024” obtained by integrating the number “256” which can be specified by the line number and the number “4” of the ways.

A start address of a way 1 of the data array 20a is a local memory address of “0xA10000”. A start address of a way 2 of the data array 20a is a local memory address “0xA20000”. A start address of a way 3 of the data array 20a is a local memory address “0xA30000”. A start address of a way 4 of the data array 20a is a local memory address “0xA40000”.

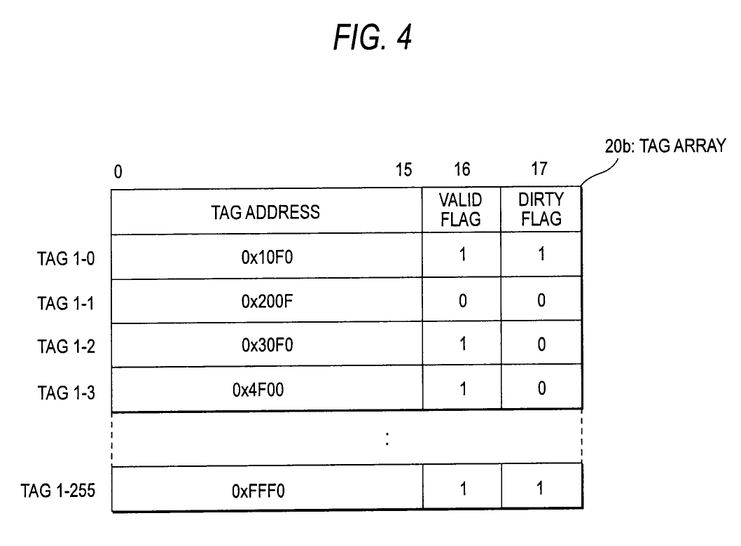

FIG. 4 shows an example of the management information (tag) added for each of the cache lines stored in the tag array 20b of the way 1.

The tag array 20b has 256 tags from “tag 1-0” to “tag 1-255” in the way 1. Each of the tags is configured by a tag address having a 16-bit width, a valid flag having a 1-bit width, and a dirty flag having a 1-bit width.

The tag address indicates a tag address of the data stored in the cache line of the corresponding data array 20a. The valid flag indicates whether the data stored in the cache line of the corresponding data array 20a are valid “1” or invalid “0”. In the case in which the valid flag is “1” and the dirty flag is “1”, it is indicated that write is performed for the data stored in the cache line of the corresponding data array 20a. The tag address, the valid flag and the dirty flag of each tag are set when the processor 10 writes data to the local memory 20.

In FIG. 4, the contents stored in the “tag 1-0” indicate that data stored in a “cache line 1-0” are valid (the valid flag of “1”) and overwrite is performed over the data (the dirty flag of “1”) , and the tag address is “0x10F0”. Similarly, the “tag 1-1” indicates that data stored in a “cache line 1-1” are invalid (the valid flag of “0”). Moreover, the “tag 1-2” indicates that data stored in a “cache line 1-2” are valid (the valid flag of “1”) and the tag address is “0x30F0”. Furthermore, the “tag 1-3” indicates that data stored in a “cache line 1-3” are valid (the valid flag of “1”) and the tag address is “0x4F00”.

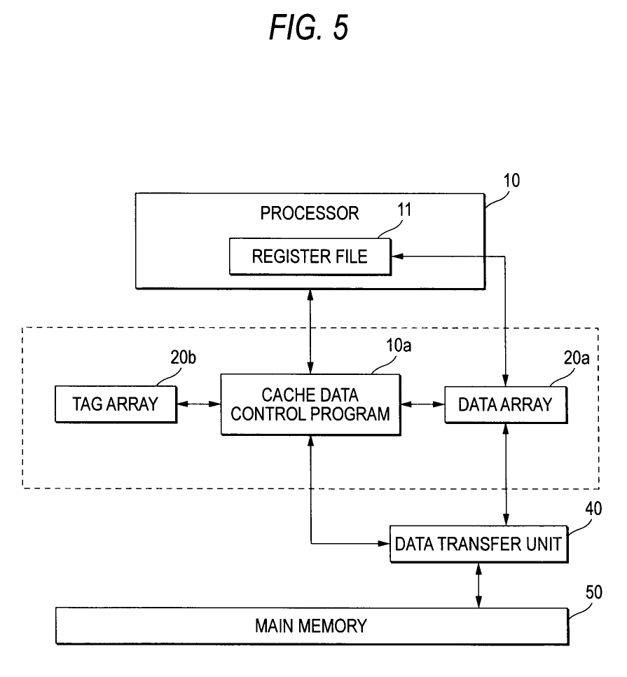

FIG. 5 is a diagram showing an input/output relationship of data to be used when the processor 10 according to the embodiment executes a cache data control program 10a. The data array 20a and the tag array 20b in the local memory 20 are accessed by the processor 10 for executing the cache data control program 10a. The processor 10 for executing the cache data control program 10a copies (stores) the data stored in the data array 20a of the local memory 20 into the register serving as the register file 11.

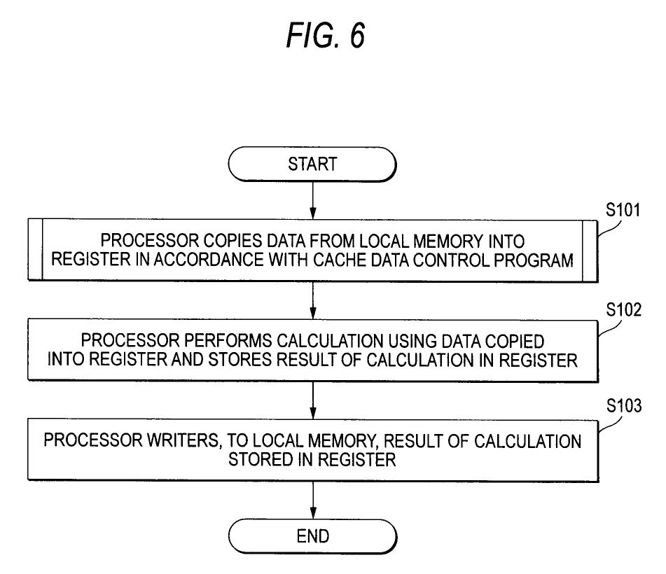

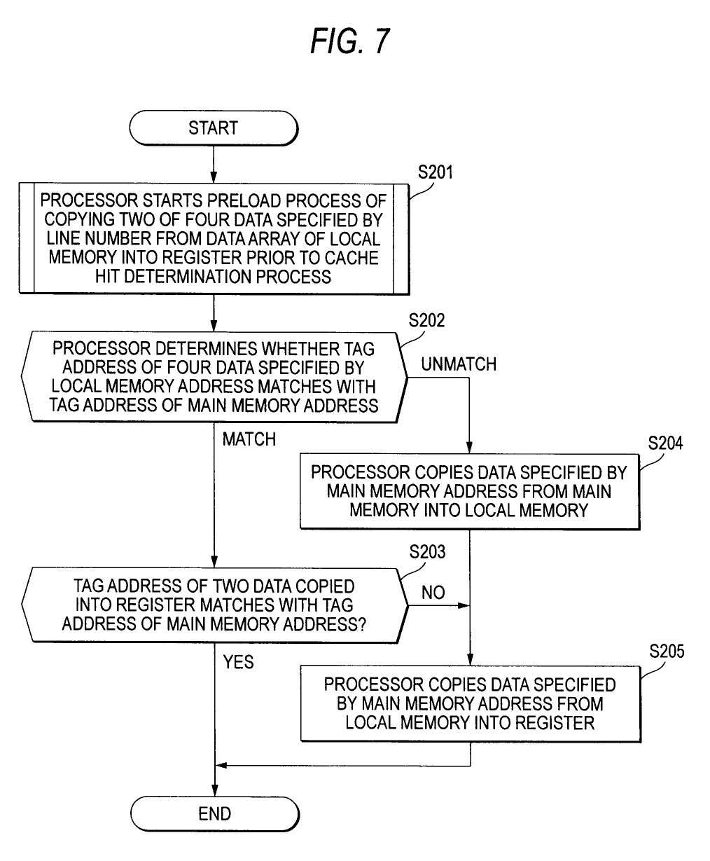

FIGS. 6 and 7 are flowcharts showing an operation of the information processing apparatus 100 according to the embodiment.

Description will be given to an operation to be performed when the processor 10 allows an access to data on the local memory 20 and performs a process by using the data as shown in FIG. 6.

The processor 10 that executes the program starts a process of allowing an access to the data to be used in the calculation process. First of all, the processor 10 copies the data to be used in the calculation process from the local memory 20 into the register in accordance with the cache data control program 10a (Step S101). The processor 10 executes, in parallel, a process of determining whether the data to be accessed have already been stored in the local memory 20 or not (a cache hit determination process) and a process of copying the data stored in the local memory 20 into the register before completing the cache hit determination process (preload process), thereby increasing a speed of a data access process. Description will be given to the details of a process to be performed when the data to be accessed are copied from the local memory 20 into the register.

Then, the processor 10 performs a process by using the data copied from the local memory 20 into the register and stores a result of the calculation in the register (Step S102).

Thereafter, the processor 10 writes, to the local memory 20, the result of the calculation which is stored in the register (Step S103).

As described above, the processor 10 allows an access to the data stored in the local memory 20 and performs the calculation process in accordance with the executed program.

Next, description will be given to the operation (Step S101) to be performed when the processor 10 executes the preload process and the cache hit determination process in parallel and copies the data to be accessed from the local memory 20 into the register in accordance with the cache data control program 10a as shown in FIG. 7.

First, the processor 10 calculates a main memory address of data to be accessed and a local memory address corresponding to the main memory address. The local memory 20 has 4-way. Therefore, data specified by the main memory address (for example, 0xFFFF0000) are cache stored in any of four cache lines (a cache line 1-0 “0xA10000”, a cache line 2-0 “0xA20000”, a cache line 3-0 “0xA30000” and a cache line 4-0 “0xA40000”) on the local memory 20 specified by a line number (0x00) of the main memory address. Accordingly, a local memory address corresponding to the main memory address (0xFFFF0000) includes “0xA10000”, “0xA20000”, “0xA30000” and “0xA40000”.

Subsequently, in step S201, the processor 10 starts a preload process before starting a cache hit determination process performed in step S202. In step S201, the processor 10 copies, from the local memory 20 into the register, data stored in two cache lines (for example, the cache lines 1-0 and 2-0) from among the four cache lines (the cache lines 1-0, 2-0, 3-0 and 4-0) that are specified by the line number (0x00) of the main memory address.

More specifically, a data transfer process is performed on a 32-bit unit between the local memory 20 and the register. Accordingly, for example, the processor 10 copies, into two registers, data (32 bits) specified by the local memory addresses (“0xA10000” to “0xA10003”) and data (32 bits) specified by the local memory addresses (“0xA20000” to “0xA20003”).

In the embodiment, it is assumed that the data stored in two cache lines are copied into the register. However, in the preload process, a number of cache lines that stores data subjected to the copy by the processor 10 may be one, two, three or four, in a case where the data array 20a and the tag array 20b are configured in 4-way.

Next, the processor 10 instantly starts a cache hit determination process without waiting for the completion of the preload process (Step S201). More specifically, the processor 10 determines whether the tag address (0xFFFF) of the acquired main memory address matches with any of tag addresses of four data specified by a local memory address corresponding to the acquired main memory address (a tag address “0x10F0” of the tag 1-0, a tag address “0xFFFF” of the tag 2-0, a tag address “0x2020” of the tag 3-0, and a tag address “0x3F30” of the tag 4-0”) or not (Step S202).

When the tag address of the acquired main memory address matches with any of the tag addresses of the four data specified by the local memory address corresponding to the main memory address (a “Cache Hit”, MATCH in Step S202), the data to be accessed by the processor 10 are stored in the local memory 20.

When the tag address (0xFFFF) of the acquired main memory address matches with any of tag addresses of two data (the cache lines 1-0 and 2-0) subjected to the preload process (the tag address “0x10F0” of the tag 1-0 and the tag address “0xFFFF” of the tag 2-0) (YES in Step S203), the processor 10 performs the preload process for the data to be accessed.

Immediately after the preload process is completed, therefore, the processor 10 selects any of two registers copying the data on the local memory 20 which stores data having an identical tag address to the tag address (0xFFFF) of the acquired main memory address and reads the data from the register, and uses the same data in the process.

More specifically, the processor 10 reads, from the register, data stored in the cache line 2-0 of the local memory 20 having the tag address “0xFFFF”, that is, data (32 bits) stored in the local memory addresses (“0xA20000” to “0xA20003”). Then, the processor 10 performs a process using the same data.

On the other hand, when the tag address of the acquired main memory address does not match with any of the tag addresses of the two data subjected to the duplication process from the local memory 20 to the register in advance (NO in Step S203), data to be accessed are present on four cache lines of the local memory 20 which are specified by the line number of the acquired main memory address and the processor 10 does not execute the preload process over the same data.

Therefore, a process (a load process) of copying, into the register, data set to be the cache hit by the cache hit determination process, that is, data having an identical tag address to the tag address of the main memory address is performed again (Step S205). Immediately after the load process is completed, the processor 10 performs the process by using the data copied into the register.

When the tag address of the acquired main memory address does not match with any of the tag addresses of the four data specified by the local memory address corresponding to the main memory address (a “Cache Miss”, UNMATCH in Step S202), the data to be accessed by the processor 10 are not stored in the local memory 20.

Therefore, the processor 10 controls the data transfer unit 40 and transfers the data specified by the main memory address from the main memory 50 to the local memory 20 and copies the data into any of the cache lines on the local memory 20 corresponding to the line number of the main memory address of the same data (Step S204).

A method of selecting “a cache line for copying data on the main memory 50” by the processor 10 will be described below.

First, the processor 10 selects a cache line having a valid flag of “0” as “a cache line for copying data on the main memory 50”. If all of valid flags of four cache lines corresponding to the line number of the main memory address are “1”, next, the processor 10 selects a cache line having a dirty flag of “0” and sets the cache line as “a cache line for copying data on the main memory 50”.

If all of the four cache lines specified by the line number of the main memory address have valid flags of “1” and dirty flags of “1”, furthermore, the processor 10 writes, to the main memory 50, data stored in one of the cache lines and selects the cache line as “a cache line for copying data on the main memory 50”.

More specifically, the processor 10 controls the data transfer unit 40, transfers the data stored in the selected cache line to the main memory 50, and sets a valid flag and a dirty flag of the cache line to be “0” and “0”. The processor 10 restores a main memory address of data stored in the selected cache line by using a line number, a tag address stored in a corresponding tag and an offset (0x00). The processor 10 writes the data stored in the selected cache line to a region on the main memory 50 specified by the reconstructed main memory address. Then, the processor 10 sets the selected cache line as “a cache line for copying data on the main memory 50”.

Next, the data specified by the acquired main memory address are copied from the main memory 50 into the local memory 20, and the processor 10 then performs a process (a load process) of further copying, into the register, the data copied into the local memory 20 (Step S205). Immediately after the load process is completed, the processor 10 performs the process by using the data copied into the register.

As described above, the processor 10 performs the preload process and the cache hit determination process in parallel in accordance with the cache data control program 10a and copies the data to be accessed from the local memory 20 into the register.

When allowing an access to the data stored in the local memory 20, the processor 10 starts the preload process (Step S201) and starts the cache hit determination process (Step S202) without waiting for the completion of the preload process. More specifically, the processor 10 executes the preload process (Step S201) and the cache hit determination process (Step S202) in parallel.

When the cache hit is obtained in the cache hit determination process (MATCH in Step S202) and the processor 10 allows an access to the data subjected to the preload process (YES in Step S203), the processor 10 executes the preload process and the cache hit determination process in parallel and allows an access to the data copied into the register by the preload process based on the result of the decision of the cache hit determination process.

Since the preload process and the cache hit determination process are executed in parallel as described above, a time required for causing the processor 10 to allow an access to the data on the local memory 20 (a data access time) is reduced as compared with the case in which a normal load process is performed to allow an access to data after the cache hit determination process.

More specifically, as compared with the case in which the normal load process is performed after the cache hit determination process, the data access time can be reduced by either a time required for the preload process or a time required for the cache hit determination process which is shorter.

By starting the preload process before completing the cache hit determination process, it is possible to execute the preload process and the cache hit determination process in parallel and to implement a reduction in the data access time.

If the preload process is completed before the cache hit determination process is completed, moreover, the processor 10 can allow an access to the data copied into the register by the preload process immediately after the result of the decision of the cache hit determination process is determined.

On the other hand, if the cache miss is obtained in the cache hit determination process (UNMATCH in Step S202) or the cache hit is obtained in the cache hit determination process and the processor 10 does not allow an access to the data subjected to a load process prior to the cache hit determination (NO in Step S203), the processor 10 performs a normal process in the cache miss or a normal process in the cache hit. At this time, the data access time of the processor 10 is obtained by simply adding a time required for starting the preload process to a normal data access time in the cache miss or the cache hit. A small overhead is obtained by executing the load process prior to the cache hit determination process.

According to the information processing apparatus 100 in accordance with the embodiment, thus, the process of copying the data stored in the local memory 20 into the register is started before the cache hit determination process is completed. Consequently, it is possible to shorten a time required for giving a data access to the local memory 20 from the processor 10.

The processor 10 may perform the preload process into the register over all of the data stored in the four cache lines specified by the line number of the main memory address. Moreover, the processor 10 may perform the preload process into the register over one data stored in one cache line specified by the line number of the main memory address with a data array and a tag array in the local memory 20 set to be one way.

In the two cases, the processor 10 performs the preload process into the local memory 20 over all of the data stored in the cache line specified by the line number of the main memory address. In the case in which the cache hit is obtained in the cache hit determination process, therefore, the data to be accessed by the processor 10 are always subjected to the preload process into the register.

Therefore, it is not necessary to change the process to be performed by the processor 10 depending on whether the data to be accessed by the processor 10 are subjected to the preload process after the execution of the cache hit determination process. Thus, it is possible to easily control the process.

It is to be understood that the present invention is not limited to the specific embodiments described above and that the present invention can be embodied with the components modified without departing from the spirit and scope of the present invention. The present invention can be embodied in various forms according to appropriate combinations of the components disclosed in the embodiments described above. For example, some components may be deleted from all components shown in the embodiments. Further, the components in different embodiments may be used appropriately in combination.

What is claimed is:

1. An information processing apparatus comprising:
a local memory that caches a part of data stored in a main memory, which stores the data by main memory addresses, in one of a plurality of cache lines that are grouped into a plurality of ways, each of the cache lines being assigned with line numbers that are unique with one another in each of the ways, the local memory storing tag addresses that identify the data cached in the cache lines, the line numbers and the tag addresses being derivable from the main memory addresses; and
a processor that is provided with a register and operates to:
determine whether a first tag address match with a second tag address, the first tag address being derived from a target main memory address that is to be accessed for obtaining target data subjected to a computation, the second tag address being one of the tag addresses stored in the local memory;
start copying data stored in at least one of the cache lines assigned with a line number that matches with a target line number that is derived from the target main memory address into the register before completing the determination of match between the first tag address and the second tag address; and
access the register to obtain the data copied from the local memory when determined that the first tag address match with the second tag address.

2. The apparatus according to claim 1, wherein the processor operates to start copying the data stored in at least one of the cache lines assigned with the line number that matches with the target line number into the register before starting the determination of match between the first tag address and the second tag address.

3. The apparatus according to claim 1, wherein the processor operates to complete copying the data stored in at least one of the cache lines assigned with the line number that matches with the target line number into the register before completing the determination of match between the first tag address and the second tag address.

4. The apparatus according to claim 1, wherein the local memory is provided with an n-pieces of the ways, where n is an integer larger than one, and
wherein the processor operates to start copying the data stored in m-pieces of the cache lines assigned with the line number that matches with the target line number into the register, where m is an integer that satisfies 1≦m≦n.

5. The apparatus according to claim 1 further comprising a data transfer unit that manages data copy between the main memory and the local memory,
wherein the processor operates to copy data between the main memory and the local memory by controlling the data transfer unit.

6. A method for caching data in an information processing apparatus including:
a local memory that caches a part of data stored in a main memory, which stores the data by main memory addresses, in one of a plurality of cache lines that are grouped into a plurality of ways, each of the cache lines being assigned with line numbers that are unique with one another in each of the ways, the local memory storing tag addresses that identify the data cached in the cache lines, the line numbers and the tag addresses being derivable from the main memory addresses; and
a processor that is provided with a register and performs computation of the data,
wherein the method comprises:
determining whether a first tag address match with a second tag address, the first tag address being derived from a target main memory address that is to be accessed by the processor for obtaining target data subjected to the computation, the second tag address being one of the tag addresses stored in the local memory;
starting to copy data stored in at least one of the cache lines assigned with a line number that matches with a target line number that is derived from the target main memory address into the register before completing the determination of match between the first tag address and the second tag address; and
accessing the register by the processor to obtain the data copied from the local memory when determined that the first tag address match with the second tag address.

7. The method according to claim 6, wherein the copying process is started before starting the determination of match between the first tag address and the second tag address.

8. The method according to claim 6, wherein the copying process is completed before completing the determination of match between the first tag address and the second tag address.

9. The method according to claim 6, wherein the local memory is provided with an n-pieces of the ways, where n is an integer larger than one, and
wherein in the copying process, the data stored in m-pieces of the cache lines assigned with the line number that matches with the target line number into the register is started to be copied, where m is an integer that satisfies 1≦m≦n.

10. The method according to claim 6, wherein the information processing apparatus further includes a data transfer unit that manages data copy between the main memory and the local memory,
wherein the copying process is performed by the data transfer unit being controlled by the processor.

11. A computer-readable storage medium that stores a program for caching data in an information processing apparatus including:
a local memory that caches a part of data stored in a main memory, which stores the data by main memory addresses, in one of a plurality of cache lines that are grouped into a plurality of ways, each of the cache lines being assigned with line numbers that are unique with one another in each of the ways, the local memory storing tag addresses that identify the data cached in the cache lines, the line numbers and the tag addresses being derivable from the main memory addresses; and
a processor that is provided with a register and performs computation of the data,
wherein the program causes the processor to perform a process comprising:
determining whether a first tag address match with a second tag address, the first tag address being derived from a target main memory address that is to be accessed by the processor for obtaining target data subjected to the computation, the second tag address being one of the tag addresses stored in the local memory;
starting to copy data stored in at least one of the cache lines assigned with a line number that matches with a target line number that is derived from the target main memory address into the register before completing the determination of match between the first tag address and the second tag address; and
accessing the register by the processor to obtain the data copied from the local memory when determined that the first tag address match with the second tag address.

12. The storage medium according to claim 11, wherein the copying process is started before starting the determination of match between the first tag address and the second tag address.

13. The storage medium according to claim 11, wherein the copying process is completed before completing the determination of match between the first tag address and the second tag address.

14. The storage medium according to claim 11, wherein the local memory is provided with an n-pieces of the ways, where n is an integer larger than one, and
wherein in the copying process, the data stored in m-pieces of the cache lines assigned with the line number that matches with the target line number into the register is started to be copied, where m is an integer that satisfies 1≦m≦n.

15. The storage medium according to claim 11, wherein the information processing apparatus further includes a data transfer unit that manages data copy between the main memory and the local memory,
wherein the copying process is performed by the data transfer unit being controlled by the processor.
